(19) United States
(12) Patent Application Publication
(10) Pub. No.: US 2010/0078000 A1
(43) Pub. Date: Apr. 1, 2010

(54) AIR-FUEL RATIO CONTROL DEVICE OF INTERNAL COMBUSTION ENGINE

(75) Inventor: Yuri SAKAMOTO, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/569,239

(22) Filed: Sep. 29, 2009

(30) Foreign Application Priority Data
Sep. 30, 2008 (JP) 2008-255529
Sep. 30, 2008 (JP) 2008-255530

(51) Int. Cl. F02D 41/00; F02D 45/00; F01N 3/10; F01N 11/00

(52) U.S. Cl. 123/672; 60/285; 60/299; 60/277

(57) ABSTRACT

When an output of a downstream sensor provided downstream of a catalyst for exhaust gas purification becomes a leaner value than a leanness determination value, an air-fuel ratio control device supplies a rich component to the catalyst by performing rich input processing, in which increase correction for increasing fuel injection quantity stepwise is performed and then increase correction quantity of the fuel injection quantity is decreased gradually. When the increase correction quantity of the fuel injection quantity defined by the rich input processing becomes zero or when oxygen occlusion quantity of the catalyst becomes zero, the control device supplies a lean component to the catalyst by performing lean input processing, in which decrease correction for decreasing the fuel injection quantity stepwise is performed and then decrease correction quantity of the fuel injection quantity is decreased gradually.

### CROSS REFERENCE TO RELATED APPLICATION

This application is based on and incorporates herein by reference Japanese Patent Applications No. 2008-255529 filed on Sep. 30, 2008 and No. 2008-255530 filed on Sep. 30, 2008.

### BACKGROUND OF THE INVENTION

1. Field of the Invention

The present invention relates to an air-fuel ratio control device of an internal combustion engine having a downstream sensor provided downstream of a catalyst, which purifies exhaust gas, for sensing an air-fuel ratio or a rich/lean state of the exhaust gas.

The present invention also relates to an air-fuel ratio control device of an internal combustion engine having sensors provided respectively upstream and downstream of a catalyst, which purifies exhaust gas of the internal combustion engine, each for sensing an air-fuel ratio or a rich/lean state of the exhaust gas.

2. Description of Related Art

Among recent automobile exhaust gas purification systems, there is a system that has sensors (air-fuel ratio sensors or oxygen sensors) arranged respectively upstream and downstream of a catalyst, which purifies exhaust gas, each for sensing an air-fuel ratio or a rich/lean state of the exhaust gas and that performs main feedback control and sub feedback control in order to heighten an exhaust gas purification rate of the catalyst. The main feedback control is to perform feedback correction of fuel injection quantity to conform the air-fuel ratio upstream of the catalyst to a target air-fuel ratio based on an output of the upstream sensor. The sub feedback control is to correct the target air-fuel ratio of the main feedback control or to modify feedback correction quantity of the main feedback control or the fuel injection quantity based on an output of the downstream sensor.

As an example of such the system that performs the main feedback control and the sub feedback control, there is a system as described in Patent document 1 (Japanese Patent Gazette No. 2518247) that increases updating quantity of an air-fuel ratio feedback control constant as deviation of the air-fuel ratio sensed with the downstream sensor from the target air-fuel ratio (i.e., the theoretical air-fuel ratio) increases and calculates air-fuel ratio correction quantity in accordance with the output of the upstream sensor and the air-fuel ratio feedback control constant. There is also a system as described in Patent document 2 (Japanese Patent Gazette No. 3826996) that sets an intermediate target value between the air-fuel ratio sensed with the downstream sensor and the downstream target air-fuel ratio and calculates the correction quantity of the upstream target air-fuel ratio based on the air-fuel ratio sensed with the downstream sensor and the intermediate target value. Thus, theses systems aim to smoothly converge the air-fuel ratio downstream of the catalyst to the target air-fuel ratio.

If the air-fuel ratio of the exhaust gas flowing into the catalyst becomes lean due to fuel cut, oxygen occlusion quantity of the catalyst becomes excessive, so a purification rate of NOx (as a lean component) lowers. As a countermeasure against it, for example as described in Patent document 3 (JP-A-H08-193537) or Patent document 4 (JP-A-2006-19418), there is a system that controls the air-fuel ratio to be rich temporarily when the fuel injection is resumed after the end of the fuel cut (i.e., at timing of recovery from the fuel cut), thereby decreasing the oxygen occlusion quantity of the catalyst and improving the NOx purification rate.

If a lean disturbance, which causes the air-fuel ratio of the exhaust gas flowing into the catalyst to become lean, occurs as shown in FIG. 21, there is a possibility that the oxygen occlusion quantity of the catalyst becomes excessive and the purification rate of NOx (as the lean component) lowers. However, if the control is performed to smoothly change the air-fuel ratio downstream of the catalyst in a rich direction (i.e., a direction toward a richer air-fuel ratio) such that the air-fuel ratio converges to the target air-fuel ratio by the air-fuel ratio control as described in above Patent document 1 or Patent document 2 when the lean disturbance occurs, the oxygen occlusion quantity of the catalyst cannot be decreased quickly. A/Fdown in FIG. 21 shows the output of the downstream sensor. As a result, there is a possibility that a state of the lowered NOx purification rate lengthens and NOx emission quantity increases as shown in FIG. 21. Moreover, in this case, the oxygen occlusion quantity decreases gradually from an upstream side portion (i.e., a front side portion) of the catalyst and eventually the oxygen occlusion quantity remains only in a downstream side portion (i.e., a rear side portion) of the catalyst. As a result, a distribution of the oxygen occlusion quantity inside the catalyst turns into a distribution lopsided toward the downstream side portion of the catalyst. Therefore, when a rich disturbance, which causes the air-fuel ratio of the exhaust gas flowing into the catalyst to become rich, occurs thereafter, there is a possibility that the rich components such as HC and CO cannot be purified efficiently and the exhaust emission worsens.

Also in the case where the air-fuel ratio is temporarily controlled to be rich (as shown by COMMAND A/F in FIG. 22) at the resumption of the fuel injection after the end of the fuel cut as in the technology of above Patent document 3 or Patent document 4, the oxygen occlusion quantity (OCC in FIG. 22) decreases gradually from an upstream side portion (i.e., a front side portion) of the catalyst and eventually the oxygen occlusion quantity tends to remain only in a downstream side portion. Therefore, when the rich disturbance occurs thereafter, there is a possibility that the rich components such as HC and CO cannot be purified efficiently and the exhaust emission worsens. OCCmax in FIG. 22 represents the maximum oxygen occlusion quantity of the catalyst. Part A of FIG. 22 shows a state where the oxygen is occluded in the entire catalyst. Part B of FIG. 22 shows a state where the oxygen is occluded in the downstream portion of the catalyst.

Among recent automobile exhaust gas purification systems, there is further a system that has sensors (air-fuel ratio sensors or oxygen sensors) respectively upstream and downstream of a catalyst, which purifies exhaust gas of the internal combustion engine, each for sensing an air-fuel ratio or a rich/lean state of the exhaust gas and that performs main feedback control and sub feedback control in order to heighten an exhaust gas purification rate of the catalyst. The main feedback control is to perform feedback correction of fuel injection quantity to conform an air-fuel ratio upstream of the catalyst to a target air-fuel ratio based on an output of the upstream sensor. The sub feedback control is to correct the target air-fuel ratio of the main feedback control or to modify feedback correction quantity of the main feedback control or the fuel injection quantity based on an output of the downstream sensor.

As a system that performs the above main feedback control and sub feedback control, there is a system as described in Patent document 5 (JP-A-2002-227689) that corrects a control gain of the sub feedback control and the like in accordance with an operation state of the internal combustion engine (for example, rotation speed or intake air quantity) or a state of the catalyst (for example, a degradation degree) in order to ensure stable exhaust gas purification performance without being affected by the operation state of the internal combustion engine or the state of the catalyst.

There is also a system as described in Patent document 6 (JP-A-2004-360605) that senses an oxygen occlusion capacity of the catalyst as information about a degradation degree of the catalyst and corrects a control parameter of the internal combustion engine in accordance with the degradation degree (i.e., the oxygen occlusion capacity) of the catalyst.

If the air-fuel ratio of the exhaust gas flowing into the catalyst fluctuates due to the disturbance or the like and the air-fuel ratio downstream of the catalyst (i.e., the output of the downstream sensor) fluctuates, correction quantity defined by the sub feedback control (i.e., sub correction quantity) changes correspondingly in the system that performs the main feedback control and the sub feedback control, The system purifies the exhaust gas with the catalyst efficiently by modifying the main feedback control or the fuel injection quantity with the sub correction quantity. However, there is a possibility that a behavior (an output waveform) of the sub correction quantity changes due to an individual difference or degradation (aging change) of the system (including the catalyst and the sensors). The behavior of the sub correction quantity changes also according to the kind of the degradation of the catalyst (such as loss of the ceria that occludes the oxygen or condensation of the precious metals contributing to reaction speed). If the change (deviation) of the behavior of the sub correction quantity due to such the individual difference or degradation of the system enlarges, there is a possibility that the exhaust gas cannot be purified efficiently with the catalyst.

If the control gain or the control parameter is simply changed in accordance with the degradation degree of the catalyst as in the technology of above Patent document 5 or Patent document 6, the change (deviation) of the behavior of the sub correction quantity due to the individual difference or the degradation of the system cannot be modified with high precision, and there is a possibility that the exhaust gas cannot be purified efficiently with the catalyst.

### SUMMARY OF THE INVENTION

It is an object of the present invention to provide an air-fuel ratio control device of an internal combustion engine capable of efficiently reducing NOx emission quantity when a lean disturbance occurs and efficiently purifying a rich component when a rich disturbance occurs after the occurrence of the lean disturbance.

It is another object of the present invention to provide an air-fuel ratio control device of an internal combustion engine capable of precisely modifying change of a behavior of sub correction quantity (correction quantity defined by sub feedback control) and efficiently purifying exhaust gas with a catalyst.

According to a first example aspect of the present invention, an air-fuel ratio control device of an internal combustion engine having a downstream sensor provided downstream of a catalyst, which purifies exhaust gas of the internal combustion engine, for sensing an air-fuel ratio or a rich/lean state of the exhaust gas has an air-fuel ratio controlling section and a setting section included in the air-fuel ratio controlling section. The air-fuel ratio controlling section performs rich/lean input control for supplying a rich component to the catalyst by performing rich input processing when an output of the downstream sensor becomes a leaner value than a certain leanness determination value and for supplying a lean component to the catalyst by performing lean input processing when increase correction quantity of fuel injection quantity defined by the rich input processing becomes zero or when oxygen occlusion quantity of the catalyst becomes zero. In the rich input processing, increase correction is performed to increase the fuel injection quantity stepwise by a certain rich step quantity and then the increase correction quantity of the fuel injection quantity is decreased gradually. In the lean input processing, decrease correction is performed to decrease the fuel injection quantity stepwise by a certain lean step quantity and then decrease correction quantity of the fuel injection quantity is decreased gradually. The setting section sets total quantity of the rich component supplied to the catalyst by the rich input processing of the rich/lean input control to a value equal to or larger than an oxygen occlusion capacity of the catalyst.

With the above construction, when the oxygen occlusion quantity of the catalyst becomes excessive and a purification rate of NOx (as a lean component) lowers to an extent that the output of the downstream sensor becomes a leaner value than the leanness determination value due to occurrence of a lean disturbance, which causes the air-fuel ratio of the exhaust gas flowing into the catalyst to become lean, the oxygen occlusion quantity of the catalyst can be decreased by performing the rich input processing and thus supplying the rich component to the catalyst. At that time, the total quantity of the rich component supplied to the catalyst is set to a value equal to or larger than the oxygen occlusion capacity (i.e., the maximum oxygen occlusion quantity) of the catalyst. Therefore, the oxygen occlusion quantity of the catalyst can be quickly decreased to substantially zero, and the NOx purification rate can be improved quickly. Thus, the NOx emission quantity can be reduced when the lean disturbance occurs.

Furthermore, when the fuel correction quantity defined by the rich input processing becomes zero or when the oxygen occlusion quantity of the catalyst becomes zero, the oxygen occlusion quantity of the catalyst can be increased to an appropriate value quickly by performing the lean input processing and thus supplying the lean component to the catalyst. At that time, the lean component can be supplied to the catalyst by performing the lean input processing in a state where the oxygen occlusion quantity of the entire catalyst is once brought to substantially zero by the rich input processing. Accordingly, the catalyst can be brought to a state where the oxygen is occluded in an upstream side portion (i.e., a front side portion) of the catalyst. As a result, the rich components such as HC and CO can be purified efficiently when a rich disturbance occurs after the occurrence of the lean disturbance.

The present invention may be applied to a system that performs the rich/lean input control by feedforward control (open-loop control). In addition, the present invention may be applied to a system having a following construction. That is, according to a second example aspect of the present invention, the internal combustion engine is provided also with an upstream sensor upstream of the catalyst for sensing the air-fuel ratio or the rich/lean state of the exhaust gas. The air-fuel ratio controlling section has a feedback control section for performing main feedback control and sub feedback control. In the main feedback control, feedback correction of the fuel injection quantity is performed based on an output of the upstream sensor such that the air-fuel ratio upstream of the catalyst conforms to a target air-fuel ratio. In the sub feedback control, the main feedback control or the fuel injection quantity is modified based on the output of the downstream sensor. The air-fuel ratio controlling section has an input control section for performing the rich/lean input control by using a control structure of the sub feedback control capable of realizing the rich/lean input control and/or a control parameter of the sub feedback control. With such the construction, the rich/lean input control can be performed with high precision by the sub feedback control based on the output of the downstream sensor.

According to a third example aspect of the present invention, the air-fuel ratio controlling section sets the rich step quantity based on properties of the catalyst when the air-fuel ratio controlling section performs the increase correction for increasing the fuel injection quantity stepwise by the rich step quantity through the rich input processing of the rich/lean input control. With such the construction, the emission of the rich component such as CO can be reduced by setting the rich step quantity based on the properties of the catalyst (such as performance and specifications) to prevent occurrence of escaping. The escaping is a phenomenon that the rich component such as CO is discharged while the rich component does not participate in an adsorption reaction or a desorption reaction in the catalyst. At the same time, by setting the rich step quantity such that a water-gas-shift reaction (CO+H₂O→H₂O →H₂+CO₂) occurs in the catalyst, the purification of NOx can be promoted with the strong reducing power of H₂ generated by the water-gas-shift reaction.

According to a fourth example aspect of the present invention, the air-fuel ratio controlling section changes the increase correction quantity in accordance with an index indicating an internal state of the catalyst when the air-fuel ratio controlling section gradually decreases the increase correction quantity of the fuel injection quantity through the rich input processing of the rich/lean input control. The supply quantity of the rich component necessary for purifying NOx efficiently changes in accordance with the indices indicating the internal state of the catalyst (such as oxygen occlusion quantity, an adsorption rate, a desorption rate and a reaction delay). Therefore, with the above construction, the supply quantity of the rich component can be decreased while the supply quantity is controlled to an appropriate value (i.e., supply quantity necessary for purifying NOx efficiently) by changing the increase correction quantity of the fuel injection quantity in response to the change in the supply quantity of the rich component necessary for purifying NOx efficiently. As a result, NOx can be purified efficiently without causing the escaping of the rich component such as CO.

According to a fifth example aspect of the present invention, the air-fuel ratio controlling section has another setting section for setting total quantity of the lean component supplied to the catalyst through the lean input processing of the rich/lean input control in accordance with the oxygen occlusion capacity of the catalyst. With such the construction, the oxygen occlusion quantity of the catalyst can be quickly increased to an appropriate value corresponding to the oxygen occlusion capacity of the catalyst (e.g., 30% to 40% of the maximum oxygen occlusion quantity) by the lean input processing after the rich input processing. Thus, the catalyst can be maintained in a state of the high exhaust gas purification rate (i.e., a state where the purification rate is high regarding both of the rich component and the lean component).

According to a sixth example aspect of the present invention, an air-fuel ratio control device of an internal combustion engine having sensors provided respectively upstream and downstream of a catalyst, which purifies exhaust gas of the internal combustion engine, each for sensing an air-fuel ratio or a rich/lean state of the exhaust gas has a main feedback control section, a sub feedback control section and a control parameter changing section. The main feedback control section performs main feedback control for performing feedback correction of fuel injection quantity such that the air-fuel ratio upstream of the catalyst conforms to a target air-fuel ratio based on an output of the upstream sensor. The sub feedback control section performs sub feedback control for modifying the main feedback control or the fuel injection quantity based on an output of the downstream sensor. The control parameter changing section performs control parameter changing processing for detecting a behavior of sub correction quantity information, which is correction quantity defined by the sub feedback control or information related to the correction quantity, when an output of the downstream sensor crosses a predetermined value during execution of the main feedback control and the sub feedback control and for changing a control parameter of the sub feedback control based on a result of comparison between the behavior of the sub correction quantity information and a predetermined reference behavior.

The above construction detects the behavior of the sub correction quantity information when the output of the downstream sensor fluctuates and crosses the predetermined value due to the disturbance or the like during the execution of the main feedback control and the sub feedback control. The construction compares the behavior of the sub correction quantity information and the predetermined reference behavior. Thus, change (deviation) of the behavior of the sub correction quantity information due to an individual difference or degradation (aging change) of the system can be determined with high precision. Thus, the change of the behavior of the sub correction quantity information due to the individual difference or the degradation of the system can be modified with high precision by changing the control parameter of the sub feedback control such that the behavior of the sub correction quantity information conforms to the reference behavior based on the comparison result. As a result, the exhaust gas can be efficiently purified with the catalyst.

According to a seventh example aspect of the present invention, in the above air-fuel ratio control device according to the sixth example aspect, the control parameter changing section has a modifying section for modifying the behavior of the sub correction quantity information by performing the control parameter changing processing as needed during an operation of the internal combustion engine. With such the construction, the control parameter changing processing is performed as needed during the operation of the internal combustion engine, e.g., every time the output of the downstream sensor crosses a predetermined value during the execution of the main feedback control and the sub feedback control. Thus, the change of the behavior of the sub correction quantity information due to the individual difference or the degradation of the system can be modified. Accordingly, the change of the behavior of the sub correction quantity information can be modified in an early stage during the operation of the internal combustion engine, and deterioration of the exhaust emission can be prevented.

According to an eighth example aspect of the present invention, in the above air-fuel ratio control device according to the sixth example aspect, the control parameter changing section has an obtaining section for obtaining an adapted value of a control parameter of the sub feedback control by performing the control parameter changing processing during control system adaptation of the internal combustion engine, With such the construction, the control parameter changing processing of the present invention is performed during the control system adaptation in a development phase or a design phase of the control system of the internal combustion engine. Thus, the control parameter of the sub feedback control is changed to conform the behavior of the sub correction quantity information to the reference behavior. In this way, the adapted values of the control parameters of the sub feedback control can be calculated with high precision, and the optimum control parameters can be set. Moreover, when the difference between the behavior of the sub correction quantity information and the reference behavior does not decrease even with the control parameter changing processing, the cause of the shortage of the capacity of the catalyst can be clarified based on the behavior of the difference and can be reflected in the design of the catalyst.

According to a ninth example aspect of the present invention, in the above air-fuel ratio control device according to the sixth example aspect, the control parameter changing section has a setting section for setting the reference behavior in accordance with a capacity of the catalyst. Thus, even if the capacity of the catalyst (such as the maximum oxygen occlusion quantity) changes due to an individual difference or degradation of the catalyst, appropriate reference behavior corresponding to the capacity of the catalyst can be set.

According to a tenth example aspect of the present invention, in the above air-fuel ratio control device according to the sixth example aspect, the reference behavior is a behavior of the sub correction quantity information set to perform rich/lean input control for performing rich input processing when an output of the downstream sensor becomes a leaner value than a certain leanness determination value and for performing lean input processing when increase correction quantity of fuel injection quantity defined by the rich input processing becomes zero or when oxygen occlusion quantity of the catalyst becomes zero. In the rich input processing, increase correction is performed to increase the fuel injection quantity stepwise by a certain rich step quantity and then the increase correction quantity of the fuel injection quantity is decreased gradually. In the lean input processing, decrease correction is performed to decrease the fuel injection quantity stepwise by a certain lean step quantity and then decrease correction quantity of the fuel injection quantity is decreased gradually.

With such the construction, the rich/lean input control can be performed with high precision by changing the control parameters of the sub feedback control to conform the behavior of the sub correction quantity information to the reference behavior by the control parameter changing processing. In the rich/lean input control, the rich input processing is performed and the rich component is supplied to the catalyst when the oxygen occlusion quantity of the catalyst becomes excessive and the purification rate of NOx (as the lean component) lowers to an extent that the output of the downstream sensor becomes a leaner value than the leanness determination value due to the occurrence of the lean disturbance. The lean disturbance causes the air-fuel ratio of the exhaust gas flowing into the catalyst to become lean. Thus, the oxygen occlusion quantity of the catalyst can be quickly decreased to substantially zero, and the NOx purification rate can be improved quickly. Accordingly, the NOx emission quantity at the time when the lean disturbance occurs can be decreased. Furthermore, the lean input processing is performed and the lean component is supplied to the catalyst when the increase correction quantity of the fuel injection quantity defined by the rich input processing becomes zero or when the oxygen occlusion quantity of the catalyst becomes zero. Thus, the oxygen occlusion quantity of the catalyst can be increased to an appropriate value quickly. At that time, the lean component can be supplied to the catalyst by performing the lean input processing in a state where the oxygen occlusion quantity of the catalyst is once reduced to substantially zero by the rich input processing. Therefore, a state where the oxygen is occluded in an upstream portion (i.e., a front portion) of the catalyst can be provided. Accordingly, the rich components such as HC and CO can be purified efficiently when the rich disturbance occurs after the occurrence of the lean disturbance.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is a schematic configuration diagram showing an engine control system according to a first embodiment of the present invention;

FIG. 2 is a flowchart illustrating a processing flow of a rich/lean input control routine according to the first embodiment;

FIG. 3 is a time chart illustrating an execution example of rich/lean input control according to the first embodiment;

FIG. 4 is a diagram illustrating rich step quantity and lean step quantity according to the first embodiment;

FIG. 5 is a diagram illustrating a setting method of CO supply quantity according to the first embodiment;

FIG. 6 is a diagram conceptually showing an example of a map of the rich step quantity according to the first embodiment;

FIG. 7 is a diagram conceptually showing an example of a map of increase correction quantity according to the first embodiment;

FIG. 8 is a diagram illustrating a decreasing method of the increase correction quantity according to the first embodiment;

FIG. 9 is a diagram conceptually showing an example of a map of oxygen supply peak quantity according to the first embodiment;

FIG. 10 is a diagram conceptually showing an example of a map of the lean step quantity according to the first embodiment;

FIG. 11 is a diagram conceptually showing an example of a map of decrease correction quantity according to the first embodiment;

FIG. 12 is a diagram illustrating oxygen occlusion quantity maximizing an exhaust gas purification rate of a catalyst according to the first embodiment;

FIG. 13 is a time chart illustrating control parameter changing processing according to a second embodiment of the present invention;

FIG. 14 is a diagram illustrating a changing method of a control parameter according to the second embodiment;

FIG. 15 is another diagram illustrating the changing method of the control parameter according to the second embodiment;

FIG. 16 is a further diagram illustrating the changing method of the control parameter according to the second embodiment;

FIG. 17 is a diagram illustrating rich/lean input control according to the second embodiment;

FIG. 18 is a flowchart illustrating a processing flow of a control parameter changing routine according to the second embodiment;

FIG. 19 is a time chart illustrating an execution example of control parameter changing processing according to the second embodiment;

FIG. 20 is a time chart illustrating an execution example of control parameter changing processing of a modified example of the second embodiment;

FIG. 21 is a time chart illustrating an execution example of sub feedback control of a related art; and

FIG. 22 is a time chart illustrating an execution example of air-fuel ratio control subsequent to fuel cut of another related art.

### DETAILED DESCRIPTION OF EXAMPLE EMBODIMENTS

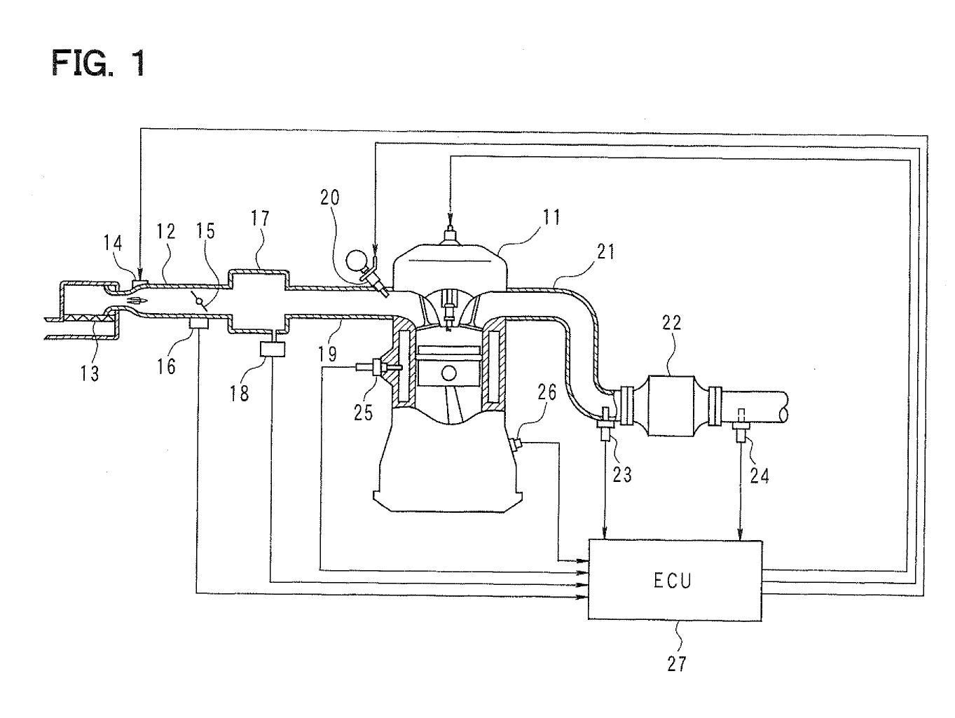

Hereafter, embodiments of the present invention will be described with reference to the drawings. First, a general configuration of an entire engine control system according to a first embodiment of the present invention will be explained with reference to FIG. 1. An air cleaner 13 is provided in a most upstream portion of an intake pipe 12 of an engine 11 (an internal combustion engine). An airflow meter 14 for sensing intake air quantity is provided downstream of the air cleaner 13. A throttle valve 15, whose opening degree is regulated by a motor (not shown), and a throttle position sensor 16 for sensing an opening degree (a throttle opening) of the throttle valve 15 are provided downstream of the airflow meter 14.

A surge tank 17 is provided downstream of the throttle valve 15, and an intake pipe pressure sensor 18 for sensing intake pipe pressure is provided to the surge tank 17. An intake manifold 19 for introducing an air into each cylinder of the engine 11 is provided to the surge tank 17. An injector 20 for injecting fuel is attached near an inlet port of the intake manifold 19 of each cylinder.

A catalyst 22 such as a three-way catalyst for purifying hazardous materials in exhaust gas (such as CO, HC and NOx) is provided in an exhaust pipe 21 of the engine 11. Sensors 23, 24 each for sensing an air-fuel ratio or a rich/lean state of the exhaust gas are provided upstream and downstream of the catalyst 22 respectively. In the present embodiment, an air-fuel ratio sensor (a linear A/F sensor) that outputs a linear air-fuel ratio signal corresponding to an air-fuel ratio of the exhaust gas is used as the upstream sensor 23. An oxygen sensor, whose output voltage reverses according to whether the air-fuel ratio of the exhaust gas is richer or leaner than the theoretical air-fuel ratio, is used as the downstream sensor 24.

A coolant temperature sensor 25 for sensing coolant temperature and a crank angle sensor 26 for outputting a pulse signal every time a crankshaft of the engine 11 rotates by a predetermined crank angle are attached to a cylinder block of the engine 11. A crank angle and engine rotation speed are sensed based on an output signal of the crank angle sensor 26.

Outputs of the above various sensors are inputted to an engine control circuit 27 (referred to as an ECU, hereinafter). The ECU 27 is constituted mainly by a microcomputer. The ECU 27 executes various kinds of engine control programs stored in an incorporated ROM (a storage medium) to control fuel injection quantity of the injector 20 and ignition timing of a spark plug (not shown) according to an engine operation state.

In that case, the ECU 27 functions as an air-fuel ratio controlling section and executes an air-fuel ratio feedback control routine (not shown) to perform main feedback control and sub feedback control. The main feedback control is to perform feedback correction of the air-fuel ratio (or the fuel injection quantity) to conform the air-fuel ratio of the exhaust gas upstream of the catalyst 22 to a target air-fuel ratio based on the output of the upstream sensor 23. The sub feedback control is to correct the fuel injection quantity or the target air-fuel ratio upstream of the catalyst 22 or to modify feedback correction quantity of the main feedback control based on the output of the downstream sensor 24 to conform the air-fuel ratio of the exhaust gas downstream of the catalyst 22 to a control target value (e.g., a value close to the theoretical air-fuel ratio).

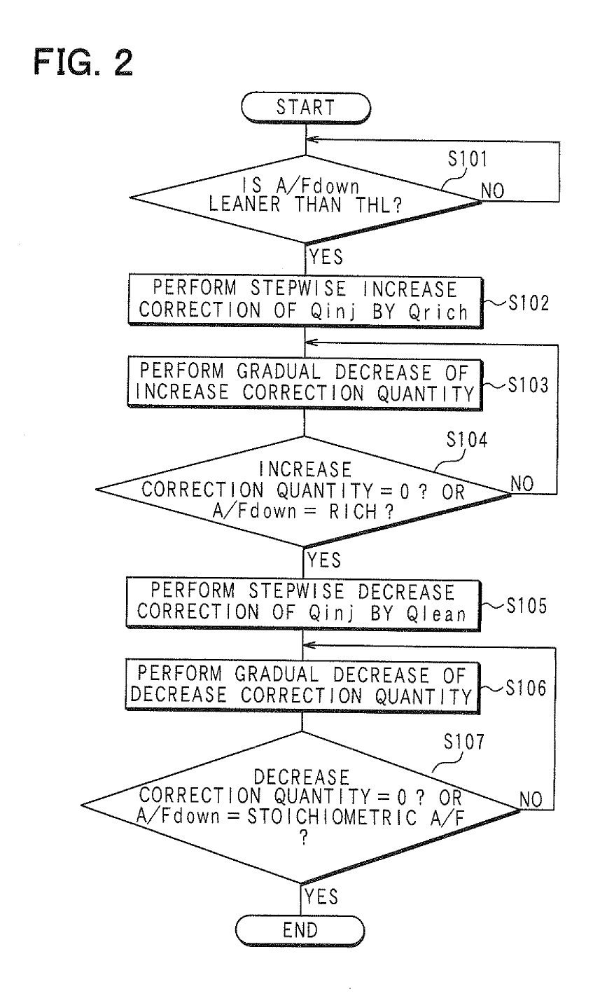

Furthermore, the ECU 27 executes a rich/lean input control routine of FIG. 2 (explained later) to perform rich/lean input control as follows.

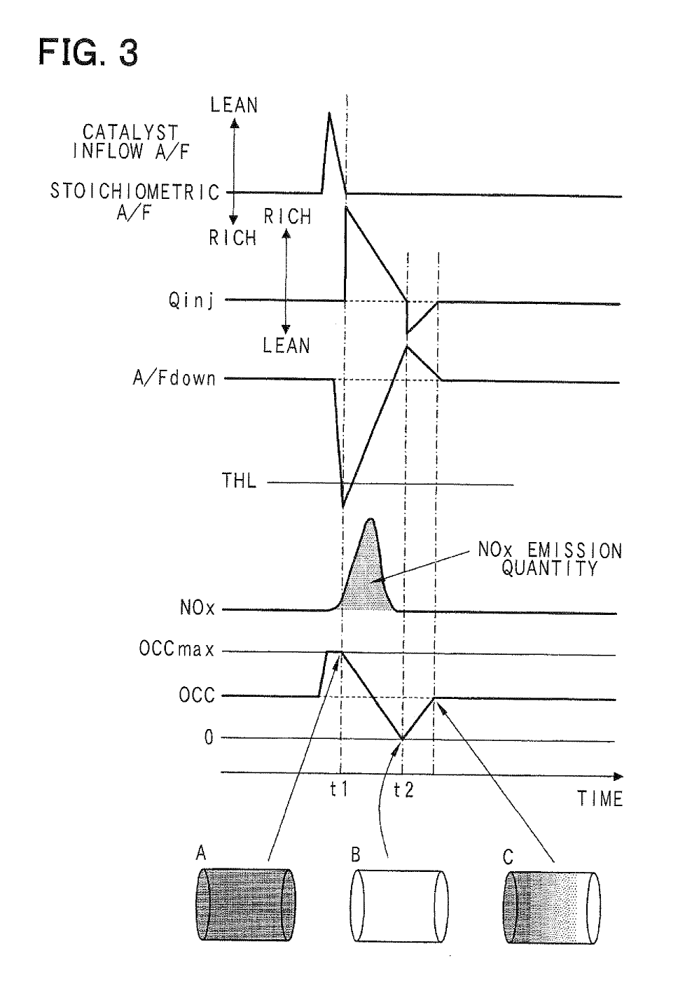

In FIG. 3, due to occurrence of a lean disturbance, which causes the air-fuel ratio of the exhaust gas flowing into the catalyst 22 to become lean, oxygen occlusion quantity OCC of the catalyst 22 becomes excessive and a purification rate of NOx (as a lean component) falls. Accordingly, the output of the downstream sensor 24 (A/Fdown in FIG. 3) becomes a leaner value than a predetermined leanness determination value THL at a time point t1. In the rich/lean input control, rich input processing is performed at the time point t1 to supply the rich component to the catalyst 22, thereby reducing the oxygen occlusion quantity of the catalyst 22. In the rich input processing, increase correction is performed to increase the fuel injection quantity Qinj stepwise by a predetermined rich step quantity and then the increase correction quantity of the fuel injection quantity Qinj is decreased gradually. At that time, total quantity of the rich component supplied to the catalyst 22 is set to a value equal to or larger than an oxygen occlusion capacity (i.e., the maximum oxygen occlusion quantity) of the catalyst 22. Thus, the oxygen occlusion quantity of the catalyst 22 is quickly reduced to substantially zero, thereby quickly improving the NOx purification rate.

Then, at a time point t2 when the increase correction quantity of the fuel injection quantity Qinj defined by the rich input processing becomes zero (or when the oxygen occlusion quantity of the catalyst 22 becomes zero), lean input processing is performed to supply the lean component to the catalyst 22. In the lean input processing, decrease correction is performed to decrease the fuel injection quantity Qinj stepwise by a predetermined lean step quantity, and then, the decrease correction quantity of the fuel injection quantity Qinj is decreased gradually. Thus, the oxygen occlusion quantity OCC of the catalyst 22 is quickly increased to an appropriate value. At that time, the lean component is supplied to the catalyst 22 by performing the lean input processing in a state where the oxygen occlusion quantity OCC of the catalyst 22 is once brought to substantially zero by the rich input processing (refer to Part B of FIG. 3). Thus, a state where the oxygen is occluded in an upstream portion (a front portion) of the catalyst 22 is provided (refer to Part C of FIG. 3). Part A of FIG. 3 shows a state where the oxygen is occluded in the entire catalyst 22.

In the present embodiment, control parameters of the sub feedback control are adjusted to realize the above-described rich/lean input control (i.e., the rich input processing and the lean input processing). For example, there may be a system that sets an intermediate target value between the air-fuel ratio sensed with the downstream sensor 24 and the target air-fuel ratio downstream of the catalyst 22 and that calculates the sub correction quantity based on the air-fuel ratio sensed with the downstream sensor 24 and the intermediate target value. The system may perform the sub feedback control for correcting the fuel injection quantity or the target air-fuel ratio upstream of the catalyst 22 with the sub correction quantity or modifying the feedback correction quantity of the main feedback control with the sub correction quantity. In the case of such the system, the rich/lean input control is realized by adjusting control parameters (control gains) used for calculating the sub correction quantity.

More specifically, correction terms Kbp, Kbi, Kp are first calculated respectively when the sub correction quantity is calculated. The correction term Kbp is calculated with a map, a mathematical expression or the like based on a previous value V(n−1) of the output of the downstream sensor 24 (i.e., the sensed air-fuel ratio A/Fdown), a proportional term PX2, an intermediate target value calculation term SF and target voltage Vtg (i.e., the target air-fuel ratio) as follows.

Kbp=f{V(n−1),PX2,SF,Vtg}

The correction term Kbi is calculated with a map, a mathematical expression or the like based on the previous value V(n−1) of the output of the downstream sensor 24, an integral term IX2, the intermediate target value calculation term SF and the target voltage Vtg as follows.

Kbi=f{V(n−1),IX2,SF,Vtg}

The correction term Kp is calculated with a map, a mathematical expression or the like based on the previous value V(n−1) of the output of the downstream sensor 24, a proportional term PX1 and the target voltage Vtg as follows.

Kp=f{V(n−1),PX1,Vtg}

Then, the sub correction quantity is calculated by a following formula using the correction terms Kbp, Kbi, Kp.

Sub correction quantity=Kbp+Kbi+Kp

In this way, the sub correction quantity is changed by adjusting the four control parameters (the control gains) of the proportional terms PX1, PX2, the integral term IX2 and the intermediate target value calculation term SF used for calculating the sub correction quantity of the sub feedback control. Thus, the rich/lean input control is realized.

Hereafter, contents of processing of the rich/lean input control routine of FIG. 2 executed by the ECU 27 will be explained. The rich/lean input control routine shown in FIG. 2 is repeatedly executed in a predetermined cycle while the sub feedback control is performed, If the routine is started, first in S101 (S means “Step”), it is determined whether the output A/Fdown of the downstream sensor 24 has become a leaner value than the leanness determination value THL, The rich input processing is started at a time point when it is determined that the output A/Fdown of the downstream sensor 24 becomes a leaner value than the leanness determination value THL.

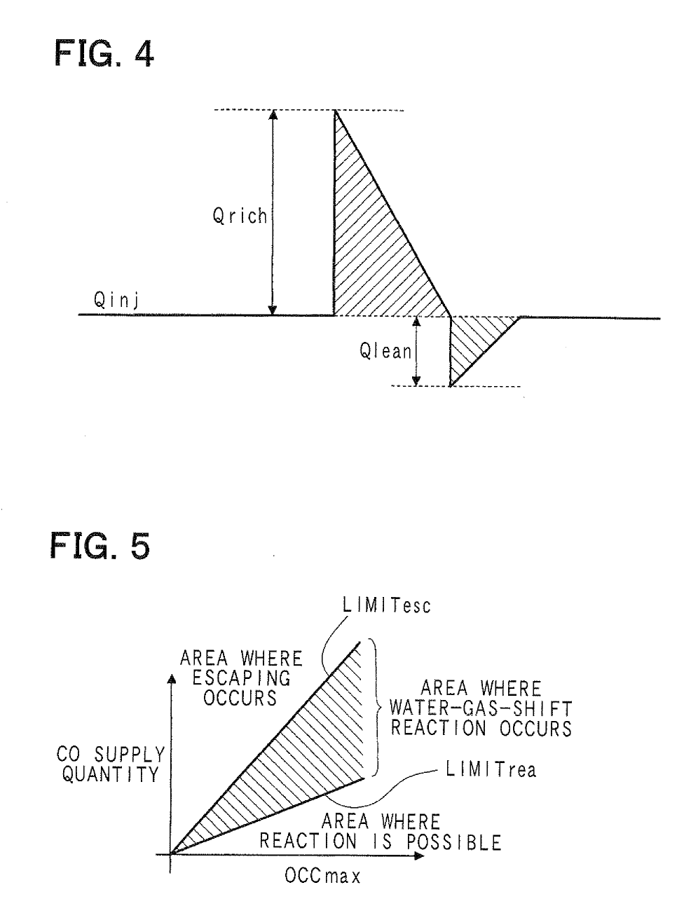

In the rich input processing, first in S102, the increase correction for increasing the fuel injection quantity Qinj stepwise by the rich step quantity Qrich is performed. At that time, the rich step quantity Qrich (refer to FIG. 4) is set based on properties of the catalyst 22 (such as performance and specifications) as follows.

First, CO supply quantity satisfying all of the following conditions (1) to (3) (i.e., CO quantity existing in a shaded area in FIG. 5) is calculated based on the maximum oxygen occlusion quantity OCCmax of the catalyst 22.

(1) A condition that the CO quantity does not cause escaping of CO, which is a phenomenon that CO is discharged while CO does not participate in an adsorption reaction or a desorption reaction in the catalyst 22. LIMITesc in FIG. 5 indicates the upper limit line, below which the escaping does not occur.

(2) A condition that the CO quantity causes a water-gas-shift reaction (CO+H₂O→H₂+CO₂) in the catalyst 22.

(3) A condition that the CO quantity is larger than upper limit quantity

(indicated by an upper limit line LIMITrea in FIG. 5) capable of reacting with the oxygen or NOx in the catalyst 22 per unit time.

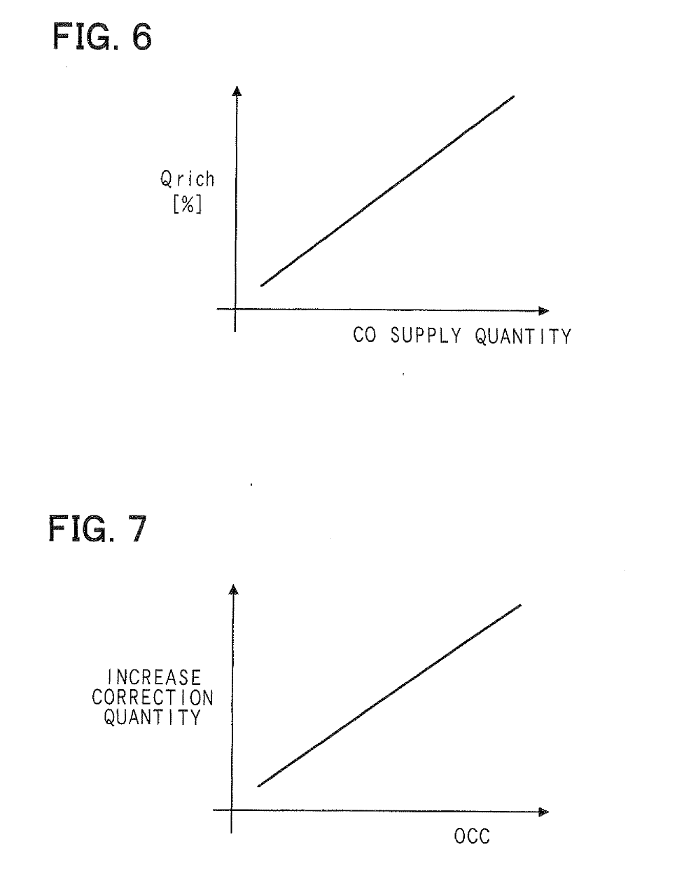

The CO supply quantity satisfying all the conditions (1) to (3) is set based on the properties of the catalyst 22 (such as the performance and the specifications). Then, the rich step quantity Qrich corresponding to the set CO supply quantity is calculated with a map (refer to FIG. 6), a mathematical expression or the like.

After the increase correction is performed to increase the fuel injection quantity Qinj stepwise by the rich step quantity Qrich, the process proceeds to S103, in which the increase correction quantity of the fuel injection quantity Qinj is decreased gradually. At that time, the increase correction quantity of the fuel injection quantity Qinj is changed in accordance with indices indicating an internal state of the catalyst 22 (such as the oxygen occlusion quantity OCC, an adsorption rate, a desorption rate and a reaction delay) as follows.

First, the oxygen occlusion quantity OCC of the catalyst 22 is calculated using the following Langmuir adsorption isotherm.

OCC=ka×P/(kd+ka×P)

In the isotherm, ka represents an adsorption rate constant, kd is a desorption rate constant and P is partial pressure of CO.

The oxygen occlusion quantity OCC of the catalyst 22 may be calculated using an adsorption isotherm other than the Langmuir adsorption isotherm (for example, the Henry adsorption isotherm, the BET adsorption isotherm, or the Freundlich adsorption isotherm), a catalyst model or the like. A reaction delay of the adsorption reaction or the desorption reaction may be taken into account when the oxygen occlusion quantity OCC of the catalyst 22 is calculated.

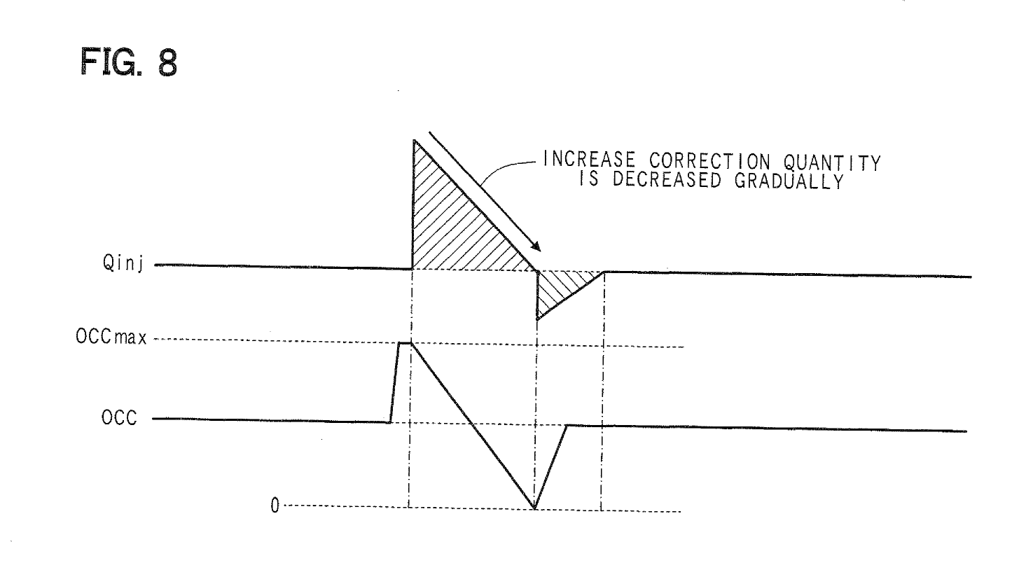

As shown in FIG. 8, when the increase correction quantity of the fuel injection quantity Qinj is decreased gradually, the supply quantity of the rich component necessary for efficiently purifying NOx changes in accordance with the oxygen occlusion quantity OCC of the catalyst 22 or the like. In response to this, the increase correction quantity corresponding to the oxygen occlusion quantity OCC of the catalyst 22 calculated in the above-described manner is calculated with a map (refer to FIG. 7), a mathematical expression or the like. Thus, the increase correction quantity of the fuel injection quantity Qinj is changed to decrease the supply quantity of the rich component while controlling the supply quantity to an appropriate value (i.e., the supply quantity necessary for purifying NOx efficiently).

By the processing of S102 and S103, the rich input processing is performed to perform the increase correction for increasing the fuel injection quantity Qinj stepwise by the rich step quantity Qrich and to gradually decrease the increase correction quantity of the fuel injection quantity Qinj thereafter. Thus, the rich component is supplied to the catalyst 22, and the oxygen occlusion quantity OCC of the catalyst 22 is decreased. At that time, the total quantity of the rich component supplied to the catalyst 22 is set to a value equal to or larger than the oxygen occlusion capacity (i.e., the maximum oxygen occlusion quantity OCCmax) of the catalyst 22. Thus, the oxygen occlusion quantity OCC of the catalyst 22 is quickly decreased to substantially zero.

Then, the process proceeds to 5104, in which it is determined whether the increase correction quantity of the fuel injection quantity Qinj defined by the rich input processing has become zero or whether the output A/Fdown of the downstream sensor 24 has changed to the richer side (i.e., whether the oxygen occlusion quantity OCC of the catalyst 22 has become zero). The rich input processing is ended and the lean input processing is started at a time point when it is determined that the increase correction quantity of the fuel injection quantity Qinj defined by the rich input processing becomes zero or that the output A/Fdown of the downstream sensor 24 changes to the richer side (i.e., that the oxygen occlusion quantity OCC of the catalyst 22 becomes zero). Alternatively, the rich input processing may be ended and the lean input processing may be started at a time point when the total quantity of the rich component supplied to the catalyst 22 by the rich input processing becomes a value equal to or larger than the oxygen occlusion capacity (i.e., the maximum oxygen occlusion quantity OCCmax) of the catalyst 22.

In the lean input processing, first in 5105, the decrease correction for decreasing the fuel injection quantity Qinj stepwise by lean step quantity Qlean is performed. At that time, the lean step quantity Qlean (refer to FIG. 4) is set as follows.

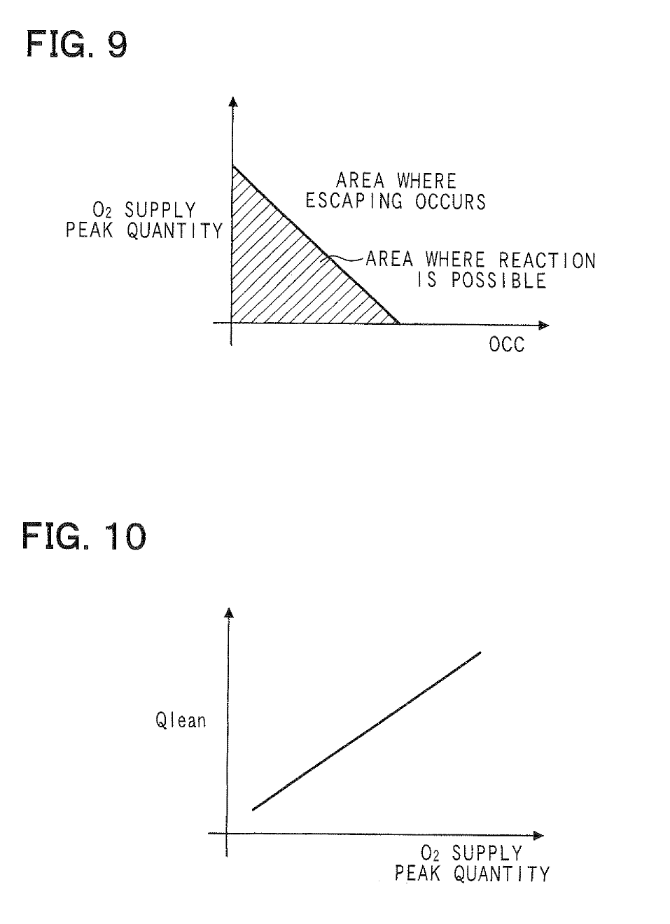

First, oxygen supply peak quantity (O₂ SUPPLY PEAK QUANTITY in FIG. 9) corresponding to the oxygen occlusion quantity OCC of the catalyst 22 is calculated with a map (refer to FIG. 9), a mathematical expression or the like. The oxygen supply peak quantity is an upper limit value of the oxygen quantity that does not cause escaping of the oxygen and that can react in the catalyst 22 per unit time. The escaping of the oxygen is a phenomenon that the oxygen is discharged while the oxygen does not participate in an adsorption reaction or a desorption reaction in the catalyst 22. The oxygen supply peak quantity may be calculated in consideration of the kind of the precious metal supported on the catalyst 22, flow velocity of the exhaust gas flowing into the catalyst 22, reaction velocity of the oxygen and the like. The lean step quantity Qlean corresponding to the oxygen supply peak quantity is calculated with a map (refer to FIG. 10) or a mathematical expression.

After the decrease correction for decreasing the fuel injection quantity Qinj stepwise by the lean step quantity Qlean is performed, the process proceeds to S106, in which the decrease correction quantity of the fuel injection quantity Qinj is decreased gradually. At that time, the decrease correction quantity of the fuel injection quantity Qinj is changed in accordance with the indices indicating the internal state of the catalyst 22 (such as the oxygen occlusion quantity OCC, the adsorption rate, the desorption rate and the reaction delay) as follows.

First, the oxygen occlusion quantity OCC of the catalyst 22 is calculated using the Langmuir adsorption isotherm, the other adsorption isotherm, the catalyst model or the like. The reaction delay of the adsorption reaction or the desorption reaction may be taken into account when the oxygen occlusion quantity OCC of the catalyst 22 is calculated.

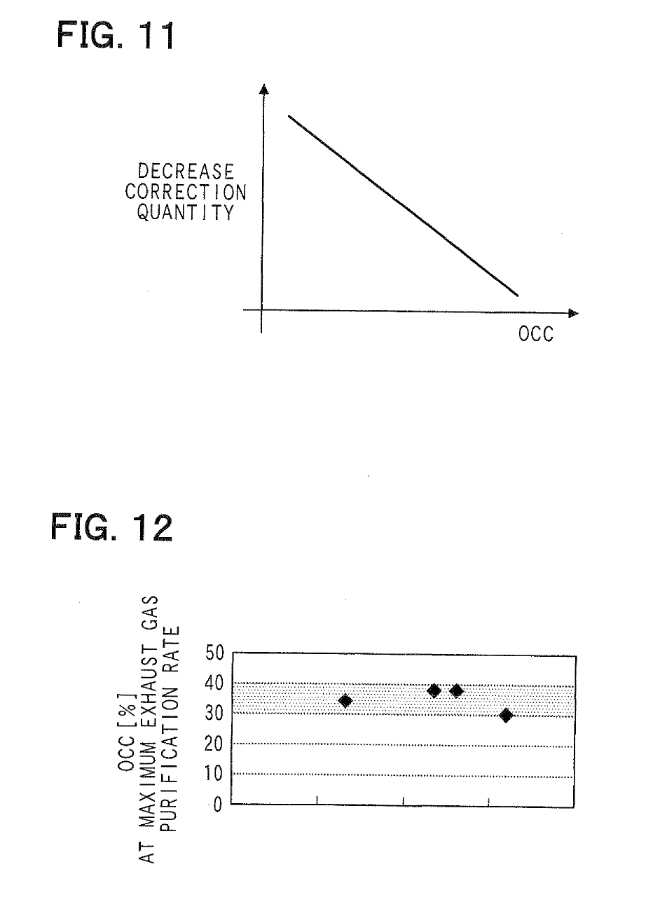

The decrease correction quantity corresponding to the thus-calculated oxygen occlusion quantity OCC of the catalyst 22 is calculated with a map (refer to FIG. 11), a mathematical expression or the like. Thus, the decrease correction quantity is decreased as the oxygen occlusion quantity OCC of the catalyst 22 increases.

By the processing of 8105 and S106, the lean input processing is performed to perform the decrease correction for decreasing the fuel injection quantity Qinj stepwise by the lean step quantity Qlean and to gradually decrease the decrease correction quantity of the fuel injection quantity Qinj thereafter. Thus, the lean component is supplied to the catalyst 22, and the oxygen occlusion quantity OCC of the catalyst 22 is increased to an appropriate value.

At that time, the total quantity of the lean component supplied to the catalyst 22 is set in accordance with the oxygen occlusion capacity (i.e., the maximum oxygen occlusion quantity OCCmax) of the catalyst 22. For example, the oxygen occlusion quantity OCC that maximizes the exhaust gas purification rate of the catalyst 22 ranges from 30% to 40% of the maximum oxygen occlusion quantity OCCmax as shown in FIG. 12. Therefore, the total quantity of the lean component supplied to the catalyst 22 is set in the range from 30% to 40% of the maximum oxygen occlusion quantity OCCmax. Thus, the oxygen occlusion quantity OCC of the catalyst 22 can be quickly increased to vicinity of the appropriate value corresponding to the oxygen occlusion capacity of the catalyst 22 (i.e., 30% to 40% of the maximum oxygen occlusion quantity OCCmax).

Then, the process proceeds to S107, in which it is determined whether the decrease correction quantity of the fuel injection quantity Qinj has become zero due to the lean input processing or whether the output A/Fdown of the downstream sensor 24 has become the stoichiometric air-fuel ratio. The lean input processing is ended at a time point when it is determined that the decrease correction quantity of the fuel injection quantity Qinj becomes zero due to the lean input processing or that the output A/Fdown of the downstream sensor 24 becomes the stoichiometric air-fuel ratio. Alternatively, the lean input processing may be ended at a time point when the total quantity of the lean component supplied to the catalyst 22 by the lean input processing becomes the appropriate value corresponding to the oxygen occlusion capacity of the catalyst 22 (i.e., 30% to 40% of the maximum oxygen occlusion quantity OCCmax of the catalyst 22).

In the above-described first embodiment, the rich input processing is performed when the output A/Fdown of the downstream sensor 24 becomes a leaner value than the leanness determination value THL. In the rich input processing, the increase correction for increasing the fuel injection quantity Qinj stepwise by the rich step quantity Qrich is performed and then the increase correction quantity of the fuel injection quantity Qinj is decreased gradually. Thus, the rich component is supplied to the catalyst 22, and the oxygen occlusion quantity OCC of the catalyst 22 is decreased. At that time, the total quantity of the rich component supplied to the catalyst 22 is set to a value equal to or larger than the oxygen occlusion capacity of the catalyst 22 (i.e., the maximum oxygen occlusion quantity OCCmax of the catalyst 22). Therefore, the oxygen occlusion quantity OCC of the catalyst 22 can be quickly decreased to substantially zero, and the NOx purification rate can be improved quickly. Thus, the NOx emission quantity at the time when the lean disturbance occurs can be reduced.

Furthermore, the lean input processing is performed when the increase correction quantity of the fuel injection quantity Qinj defined by the rich input processing becomes zero or when the oxygen occlusion quantity OCC of the catalyst 22 becomes zero. In the lean input processing, the decrease correction for decreasing the fuel injection quantity Qinj stepwise by the lean step quantity Qlean is performed and then the decrease correction quantity of the fuel injection quantity Qinj is decreased gradually. Thus, the lean component is supplied to the catalyst 22, and the oxygen occlusion quantity OCC of the catalyst 22 is quickly increased to the appropriate value. At that time, the lean component can be supplied to the catalyst 22 by performing the lean input processing in a state where the oxygen occlusion quantity OCC of the entire catalyst 22 is once brought to substantially zero by the rich input processing. Therefore, the state where the oxygen is occluded in the upstream side portion (i.e., in the front side portion) of the catalyst 22 can be provided. Accordingly, the rich components such as HC and CO can be purified efficiently when the rich disturbance occurs after the occurrence of the lean disturbance.

In the above-described first embodiment, when the increase correction for increasing the fuel injection quantity Qinj stepwise by the rich step quantity Qrich is performed by the rich input processing, the CO supply quantity that does not cause the escaping in the catalyst 22 and that causes the water-gas-shift reaction in the catalyst 22 is calculated based on the properties of the catalyst 22 (such as the performance and the specifications of the catalyst 22), and the rich step quantity Qrich corresponding to the CO supply quantity is set. Therefore, the purification of NOx can be promoted with the strong reducing power of H₂ generated by the water-gas-shift reaction while suppressing the emission of the rich components such as CO.

Furthermore, in the above first embodiment, when the increase correction quantity of the fuel injection quantity Qinj is decreased gradually by the rich input processing, the increase correction quantity is changed in accordance with the index (such as the oxygen occlusion quantity OCC, the adsorption rate, the desorption rate or the reaction delay) indicating the internal state of the catalyst 22. Therefore, in response to the phenomenon that the supply quantity of the rich component necessary for purifying NOx efficiently changes in accordance with the oxygen occlusion quantity OCC of the catalyst 22 and the like, the supply quantity of the rich component can be decreased while the supply quantity is controlled to the appropriate value (i.e., the supply quantity necessary for purifying NOx efficiently) by changing the increase correction quantity of the fuel injection quantity Qinj. Thus, NOx can be purified efficiently without causing the escaping of the rich component (such as CO).

In the above first embodiment, the total quantity of the lean component supplied to the catalyst 22 by the lean input processing is set at the appropriate value corresponding to the oxygen occlusion capacity of the catalyst 22 (i.e., 30% to 40% of the maximum oxygen occlusion quantity OCCmax). Accordingly, the oxygen occlusion quantity OCC of the catalyst 22 can be quickly increased to the vicinity of the appropriate value corresponding to the oxygen occlusion capacity of the catalyst 22 by the lean input processing after the rich input processing. Thus, the catalyst 22 can be maintained in the state of the high exhaust gas purification rate (i.e., the state where the purification rate is high regarding both of the rich component and the lean component).

In the above first embodiment, the rich/lean input control (i.e., the rich input processing and the lean input processing) is realized by adjusting the control parameters (i.e., the control gains) of the sub feedback control. Alternatively, the rich/lean input control may be realized by adjusting the target air-fuel ratio of the sub feedback control (i.e., the target air-fuel ratio downstream of the catalyst 22). Alternatively, control structure of the sub feedback control capable of realizing the rich/lean input control may be constructed.

Alternatively, a change pattern of the fuel injection quantity Qinj of the rich/lean input control may be defined beforehand, and the rich/lean input control may be performed by feedforward control (open-loop control) when the output A/Fdown of the downstream sensor 24 becomes a learner value than a predetermined leanness determination value. Alternatively, a deviation in the rich/lean input control due to the feedforward control may be corrected by the sub feedback control.

In the system configuration example of FIG. 1, the air-fuel ratio sensor is used as the upstream sensor 23, and the oxygen sensor is used as the downstream sensor 24. Alternatively, an air-fuel ratio sensor may be used also as the downstream sensor 24. Alternatively, oxygen sensors may be used as both of the upstream sensor 23 and the downstream sensor 24.

Next, a second embodiment of the present invention will be described with reference to the drawings. General configuration of the entire engine control system according to the second embodiment is the same as that of the first embodiment shown in FIG. 1. Therefore, the description thereof is not repeated here.

The ECU 27 executes various kinds of engine control programs stored in the incorporated ROM (the storage medium) to control the fuel injection quantity of the injector 20 and the ignition timing of the spark plug (not shown) according to the engine operation state.

At that time, the ECU 27 functions as a main feedback control section and also as a sub feedback control section by executing an air-fuel ratio feedback control routine (not shown). The main feedback control section performs main feedback control for performing feedback correction of the air-fuel ratio (or the fuel injection quantity) to conform the air-fuel ratio of the exhaust gas upstream of the catalyst 22 to a target air-fuel ratio based on the output of the upstream sensor 23. The sub feedback control section performs sub feedback control for correcting the fuel injection quantity or the target air-fuel ratio upstream of the catalyst 22 or for modifying feedback correction quantity of the main feedback control based on the output of the downstream sensor 24 to conform the air-fuel ratio of the exhaust gas downstream of the catalyst 22 to a control target value (e.g., a value close to the theoretical air-fuel ratio).

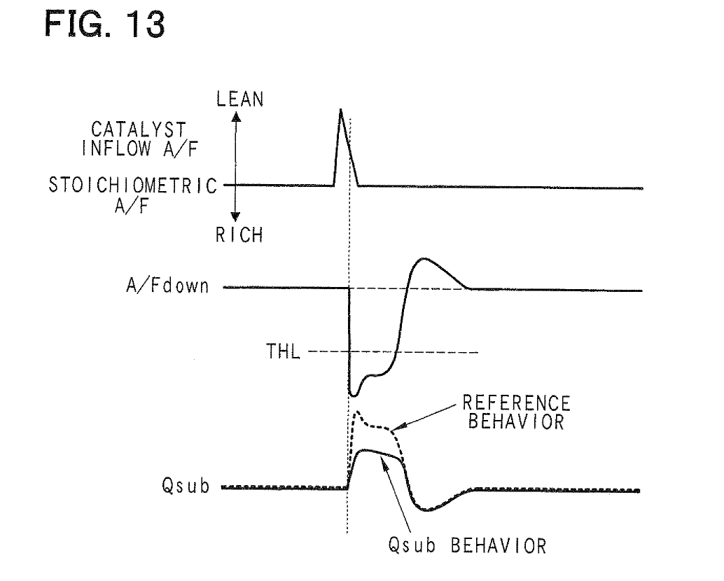

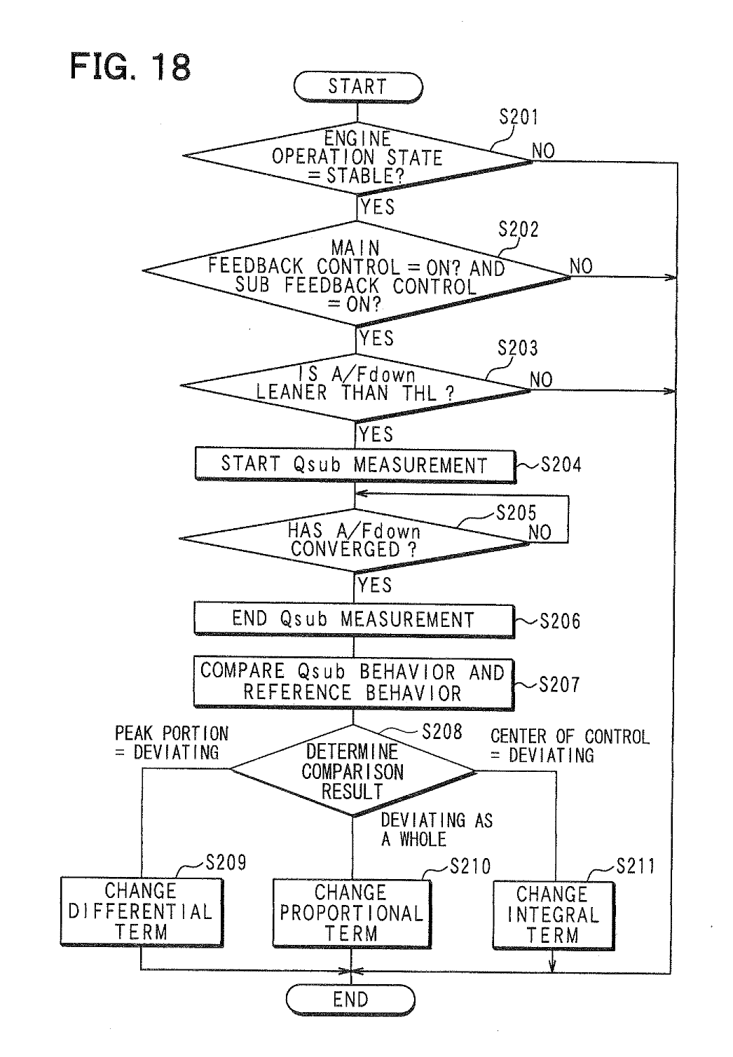

Furthermore, the ECU 27 performs a control parameter changing routine shown in FIG. 18 explained later. Thus, the ECU 27 performs control parameter changing processing when the air-fuel ratio of the exhaust gas flowing into the catalyst 22 changes in a lean direction (i.e., a direction toward a leaner air-fuel ratio) due to the disturbance and the like and the output A/Fdown of the downstream sensor 24 changes to the leaner side than a predetermined leanness determination value THL during the execution of the main feedback control and the sub feedback control as shown in FIG. 13. In the control parameter changing processing, a behavior of correction quantity defined by the sub feedback control (hereinafter, referred to as sub correction quantity Qsub) is detected, and the behavior of the sub correction quantity Qsub is compared with a predetermined reference behavior. Thus, change (deviation) of the behavior of the sub correction quantity Qsub due to an individual difference or degradation (aging change) of the system (including the catalyst 22 and the sensors 23, 24) is determined with high precision. Control parameters of the sub feedback control (such as a differential term, a proportional term and an integral term used for calculation of the sub correction quantity Qsub) are changed to conform the behavior of the sub correction quantity Qsub to the reference behavior based on the comparison result. Thus, the change of the behavior of the sub correction quantity Qsub due to the individual difference or the degradation of the system is modified with high precision.

In the present embodiment, the control parameter changing processing is performed as needed during the operation of the engine, e.g., every time the output A/Fdown of the downstream sensor 24 crosses the leanness determination value THL during the execution of the main feedback control and the sub feedback control. Thus, the change of the behavior of the sub correction quantity Qsub due to the individual difference or the degradation of the system is modified.

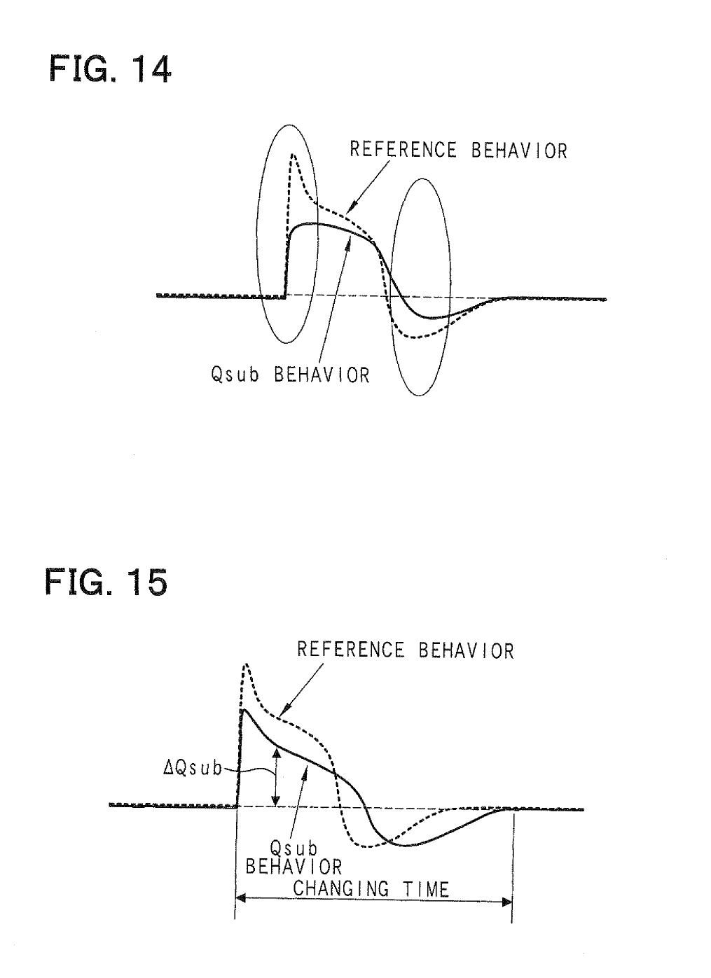

For example, when a peak portion of the behavior (i.e., an output waveform) of the sub correction quantity Qsub deviates from a peak portion of the reference behavior as shown in FIG. 14, the control parameter changing processing changes the differential term used for the calculation of the sub correction quantity Qsub to modify the behavior of the sub correction quantity Qsub such that the behavior of the sub correction quantity Qsub coincides with the reference behavior. In that case, the differential term is increased when the peak value (the absolute value) of the behavior of the sub correction quantity Qsub is smaller than the peak value (the absolute value) of the reference behavior. The differential term is decreased when the peak value (the absolute value) of the behavior of the sub correction quantity Qsub is larger than the peak value (the absolute value) of the reference behavior.

When the behavior of the sub correction quantity Qsub deviates from the reference behavior as a whole as shown in FIG. 15, the control parameter changing processing changes the proportional term used for the calculation of the sub correction quantity Qsub to modify the behavior of the sub correction quantity Qsub such that the behavior of the sub correction quantity Qsub coincides with the reference behavior. In that case, the proportional term is increased when change amount ΔQsub of the behavior of the sub correction quantity Qsub is smaller than change amount of the reference behavior. The proportional term is decreased when change amount ΔQsub of the behavior of the sub correction quantity Qsub is larger than the change amount of the reference behavior. The proportional term is increased when a changing time of the behavior of the sub correction quantity Qsub (i.e., time until the behavior converges) is longer than a changing time of the reference behavior. The proportional term is decreased when the changing time of the behavior of the sub correction quantity Qsub is shorter than the changing time of the reference behavior.

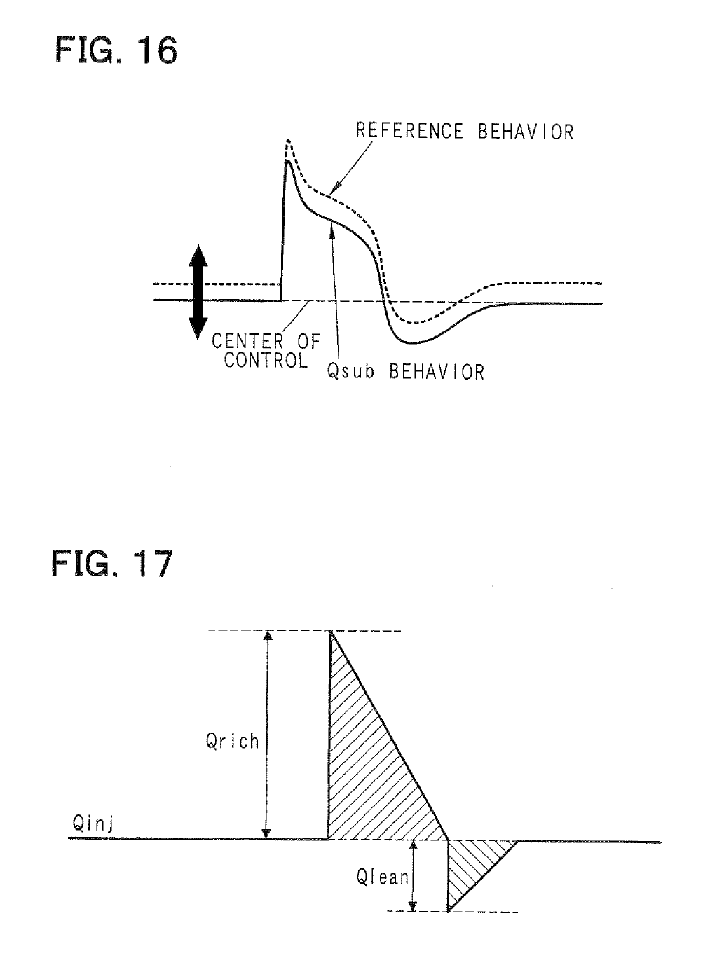

When the center of control of the behavior of the sub correction quantity Qsub deviates from the center of control of the reference behavior (i.e., when the behavior of the sub correction quantity Qsub moves in parallel to the reference behavior) as shown in FIG. 16, the control parameter changing processing changes the integral term used for the calculation of the sub correction quantity Qsub to modify the behavior of the sub correction quantity Qsub such that the behavior of the sub correction quantity Qsub coincides with the reference behavior. In that case, the integral term is increased when the center of control of the sub correction quantity Qsub deviates from the center of control of the reference behavior in a minus direction. The integral term is decreased when the center of control of the sub correction quantity Qsub deviates from the center of control of the reference behavior in a plus direction.

There may be a case where the system sets an intermediate target value between the air-fuel ratio sensed with the downstream sensor 24 and the target air-fuel ratio downstream of the catalyst 22 and calculates the sub correction quantity Qsub based on the air-fuel ratio sensed with the downstream sensor 24 and the intermediate target value. In such the case, the intermediate target value may be changed based on result of comparison between the behavior of the sub correction quantity Qsub and the reference behavior.

The reference behavior is set in accordance with the capacity of the catalyst 22. Thus, even if the capacity of the catalyst 22 (such as the maximum oxygen occlusion quantity) changes due to an individual difference or degradation of the catalyst 22, an appropriate reference behavior corresponding to the capacity of the catalyst 22 can be set. Alternatively, the reference behavior may be set using a predetermined catalyst model.

In the present embodiment, the reference behavior is set as the behavior of the sub correction quantity Qsub for performing the rich/lean input control shown in FIG. 17. In the rich/lean input control, rich input processing is performed when the output A/Fdown of the downstream sensor 24 becomes a leaner value than a certain leanness determination value THL and lean input processing is performed when increase correction quantity of the fuel injection quantity Qinj defined by the rich input processing becomes zero or when the oxygen occlusion quantity of the catalyst 22 becomes zero. In the rich input processing, increase correction for increasing the fuel injection quantity Qinj stepwise by certain rich step quantity Qrich is performed and then the increase correction quantity of the fuel injection quantity Qinj is decreased gradually. In the lean input processing, decrease correction for decreasing the fuel injection quantity Qinj stepwise by a certain lean step quantity Qlean is performed and then decrease correction quantity of the fuel injection quantity Qinj is decreased gradually.

In this case, the rich/lean input control can be performed with high precision by changing the control parameters of the sub feedback control (such as the differential term, the proportional term and the integral term used for calculation of the sub correction quantity Qsub) such that the behavior of the sub correction quantity Qsub conforms to the reference behavior through the above-described control parameter changing processing. There is a case where the oxygen occlusion quantity of the catalyst 22 becomes excessive and the purification rate of NOx (as a lean component) falls due to occurrence of a lean disturbance, whereby the output A/Fdown of the downstream sensor 24 becomes a leaner value than the leanness determination value THL. The lean disturbance is a phenomenon that causes the air-fuel ratio of the exhaust gas flowing into the catalyst 22 to become lean. At that time, the oxygen occlusion quantity of the catalyst 22 can be decreased quickly by performing the rich input processing and thus supplying the rich component to the catalyst 22 through the rich/lean input control. In this case, the oxygen occlusion quantity of the catalyst 22 can be decreased quickly to substantially zero and the NOx purification rate can be improved quickly by setting the total quantity of the rich component supplied to the catalyst 22 to a value equal to or larger than the oxygen occlusion capacity of the catalyst 22 (i.e., the maximum oxygen occlusion quantity of the catalyst 22). Thus, the NOx emission quantity at the time when the lean disturbance occurs can be reduced.

When the increase correction quantity of the fuel injection quantity Qinj defined by the rich input processing becomes zero or when the oxygen occlusion quantity of the catalyst 22 becomes zero, the oxygen occlusion quantity of the catalyst 22 can be increased to an appropriate value by performing the lean input processing and thus by supplying the lean component to the catalyst 22. At that time, the lean component can be supplied to the catalyst 22 by performing the lean input processing in a state where the oxygen occlusion quantity of the entirety of the catalyst 22 is brought to substantially zero by the rich input processing. Therefore, a state where the oxygen is occluded in the upstream side portion (i.e., in the front side portion) of the catalyst 22 can be provided. Accordingly, the rich components such as HC and CO can be purified efficiently when a rich disturbance occurs after the occurrence of the lean disturbance.

When the increase correction for increasing the fuel injection quantity Qinj stepwise by the rich step quantity Qrich is performed by the rich input processing of the rich/lean input control, the rich step quantity Qrich may be set based on properties of the catalyst 22. In this way, emission of the rich component such as CO can be reduced by setting the rich step quantity Qrich based on the properties of the catalyst 22 (such as performance and specification) to prevent escaping of the rich component. The escaping of the rich component is a phenomenon that the rich component such as CO is discharged while the rich component does not participate in the adsorption reaction or the desorption reaction in the catalyst 22. At the same time, the purification of NOx can be promoted by the strong reducing power of H₂ generated by a water-gas-shift reaction (CO+H₂O→H₂O+CO₂) by setting the rich step quantity Qrich to cause the water-gas-shift reaction in the catalyst 22.

When the increase correction quantity of the fuel injection quantity Qinj is decreased gradually by the rich input processing of the rich/lean input control, the increase correction quantity may be changed in accordance with indices indicating an internal state of the catalyst 22. Thus, in response to a phenomenon that supply quantity of the rich component necessary for efficiently purifying NOx changes in accordance with indices indicating the internal state of the catalyst 22 (such as the oxygen occlusion quantity, the adsorption rate, the desorption rate and the reaction delay), the supply quantity of the rich component can be decreased while the supply quantity is controlled to an appropriate value (i.e., the supply quantity necessary for purifying NOx efficiently) by changing the increase correction quantity of the fuel injection quantity Qinj. Accordingly, NOx can be purified efficiently without causing the escaping of the rich component such as CO.

Alternatively, the total quantity of the lean component supplied to the catalyst 22 by the lean input processing of the rich/lean input control may be set in accordance with the oxygen occlusion capacity of the catalyst 22. With such the construction, the oxygen occlusion quantity of the catalyst 22 can be quickly increased to vicinity of an appropriate value corresponding to the oxygen occlusion capacity of the catalyst 22 (for example, 30% to 40% of the maximum oxygen occlusion quantity of the catalyst 22) by the lean input processing after the rich input processing. Thus, the catalyst 22 can be brought to a state of the high exhaust gas purification rate (i.e., a state where the purification rate is high regarding both of the rich component and the lean component).

The above-described control parameter changing processing is performed by the ECU 27 according to a control parameter changing routine of FIG. 18. The control parameter changing routine shown in FIG. 18 is repeatedly performed in a predetermined cycle during the engine operation and realizes a function of a control parameter changing section. If the routine is started, first in S201, it is determined whether an engine operation state is stable. If it is determined that the engine operation state is stable, the process proceeds to S202, in which it is determined whether the main feedback control is in execution and also the sub feedback control is in execution.

If it is determined in S202 that the main feedback control is being suspended or the sub feedback control is being suspended, the routine is ended without performing processing of S203 and following steps.

If it is determined in S202 that the main feedback control is in execution and also the sub feedback control is in execution, the processing of S203 and following steps are performed as follows.

First in S203, it is determined whether the output A/Fdown of the downstream sensor 24 has become a leaner value than the leanness determination value THL. When it is determined that the output A/Fdown of the downstream sensor 24 becomes a leaner value than the leanness determination value THL, the process proceeds to S204, in which measurement of the sub correction quantity Qsub (i.e., the correction quantity defined by the sub feedback control) is started. Then, the process proceeds to S205, in which it is determined whether the output A/Fdown of the downstream sensor 24 has converged to a control target value. When it is determined that the output A/Fdown of the downstream sensor 24 converges to the control target value, the process proceeds to S206, in which the measurement of the sub correction quantity Qsub is ended.

Thus, the behavior (i.e., the output waveform) of the sub correction quantity Qsub in the period since the output A/Fdown of the downstream sensor 24 becomes the leaner value than the leanness determination value THL until the output A/Fdown converges to the control target value is detected by the processing of S203 to S206.

Then, the process proceeds to S207, in which the behavior of the sub correction quantity Qsub is compared with the reference behavior, thereby extracting differences between the behavior of the sub correction quantity Qsub and the reference behavior (such as a deviation of the peak portion, a deviation of the change amount, a deviation of the changing time and a deviation of the center of control). Then, the process proceeds to S208, in which the result of the comparison between the behavior of the sub correction quantity Qsub and the reference behavior is determined.

If it is determined in S208 that there is a state where the peak portion of the behavior of the sub correction quantity Qsub deviates from the peak portion of the reference behavior (as shown in FIG. 14), the process proceeds to S209, In S209, the differential term used for the calculation of the sub correction quantity Qsub is changed to modify the behavior of the sub correction quantity Qsub to conform the behavior of the sub correction quantity Qsub to the reference behavior. At that time, the differential term is increased when the peak value (the absolute value) of the behavior of the sub correction quantity Qsub is smaller than the peak value (the absolute value) of the reference behavior. The differential term is decreased when the peak value (the absolute value) of the behavior of the sub correction quantity Qsub is larger than the peak value (the absolute value) of the reference behavior.

When it is determined in S208 that the behavior of the sub correction quantity Qsub deviates from the reference behavior as a whole (as shown in FIG. 15), the process proceeds to S210. In S210, the proportional term used for the calculation of the sub correction quantity Qsub is changed to modify the behavior of the sub correction quantity Qsub to conform the behavior of the sub correction quantity Qsub to the reference behavior. At that time, the proportional term is increased when the change amount of the behavior of the sub correction quantity Qsub is smaller than the change amount of the reference behavior. The proportional term is decreased when the change amount of the behavior of the sub correction quantity Qsub is larger than the change amount of the reference behavior. The proportional term is increased when the changing time of the behavior of the sub correction quantity Qsub is longer than the changing time of the reference behavior. The proportional term is decreased when the changing time of the behavior of the sub correction quantity Qsub is shorter than the changing time of the reference behavior.

When it is determined in S208 that the center of control of the sub correction quantity Qsub deviates from the center of control of the reference behavior (as shown in FIG. 16), the process proceeds to S211. In S211, the integral term used for the calculation of the sub correction quantity Qsub is changed to modify the behavior of the sub correction quantity Qsub to conform the behavior of the sub correction quantity Qsub to the reference behavior. At that time, the integral term is increased when the center of control of the behavior of the sub correction quantity Qsub deviates from the center of control of the reference behavior in a minus direction. The integral term is decreased when the center of control of the behavior of the sub correction quantity Qsub deviates from the center of control of the reference behavior in a plus direction.

In this way, the control parameters of the sub feedback control are changed to conform the behavior of the sub correction quantity Qsub to the reference behavior by the processing of S209 to S211. Thus, the change of the behavior of the sub correction quantity Qsub due to the individual difference or the degradation of the system is modified.

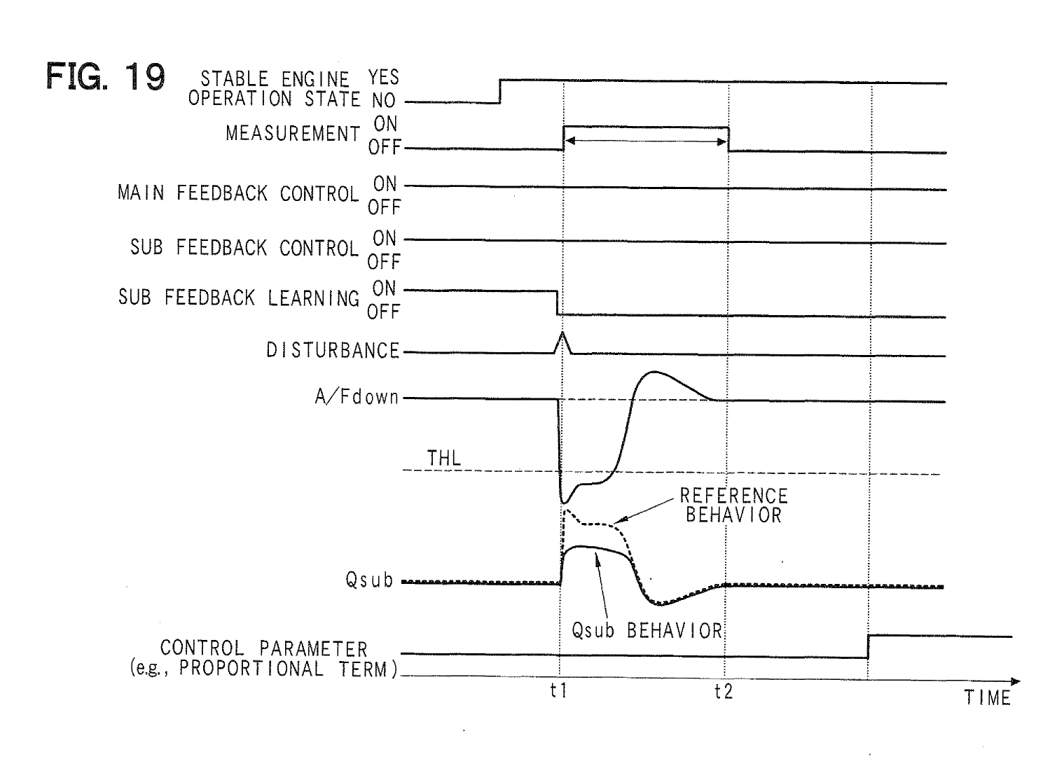

Next, an execution example of the control parameter changing processing of the above-described second embodiment will be explained with reference to a time chart of FIG. 19. In the example of FIG. 19, the air-fuel ratio of the exhaust gas flowing into the catalyst 22 changes in the lean direction due to the disturbance or the like while the main feedback control and the sub feedback control are performed in the sate where the engine operation state is stable during the engine operation. As a result, the output A/Fdown of the downstream sensor 24 becomes a leaner value than the leanness determination value THL at a time point t1. The measurement of the sub correction quantity is started at the time point t1. Thereafter, the measurement of the sub correction quantity Qsub is ended at a time point t2 when the output A/Fdown of the downstream sensor 24 converges to the control target value. Thus, the behavior (i.e., the output waveform) of the sub correction quantity Qsub in the period since the output A/Fdown of the downstream sensor 24 becomes the leaner value than the leanness determination value THL until the output A/Fdown converges to the control target value is detected. The control parameters of the sub feedback control (such as the differential term, the proportional term and the integral term used for the calculation of the sub correction quantity Qsub) are changed to conform the behavior of the sub correction quantity Qsub to the reference behavior based on the result of the comparison between the behavior of the sub correction quantity Qsub and the reference behavior.

In the above-described second embodiment, the change (the deviation) of the behavior of the sub correction quantity Qsub due to the individual difference or the degradation of the system can be determined with high precision by comparing the behavior of the sub correction quantity Qsub and the reference behavior. The control parameters of the sub feedback control are changed based on the comparison result such that the behavior of the sub correction quantity Qsub coincides with the reference behavior. Thus, the change of the behavior of the sub correction quantity Qsub due to the individual difference or the degradation of the system can be modified with high precision. As a result, the exhaust gas can be purified efficiently with the catalyst 22.

In the present embodiment, the control parameter changing processing is performed as needed during the operation of the engine, e.g., every time the output A/Fdown of the downstream sensor 24 crosses the leanness determination value THL during the execution of the main feedback control and the sub feedback control. Thus, the change of the behavior of the sub correction quantity Qsub due to the individual difference or the degradation of the system is modified. As a result, the change in the behavior of the sub correction quantity Qsub can be modified at an early stage during the engine operation, thereby preventing the deterioration of the exhaust emission.

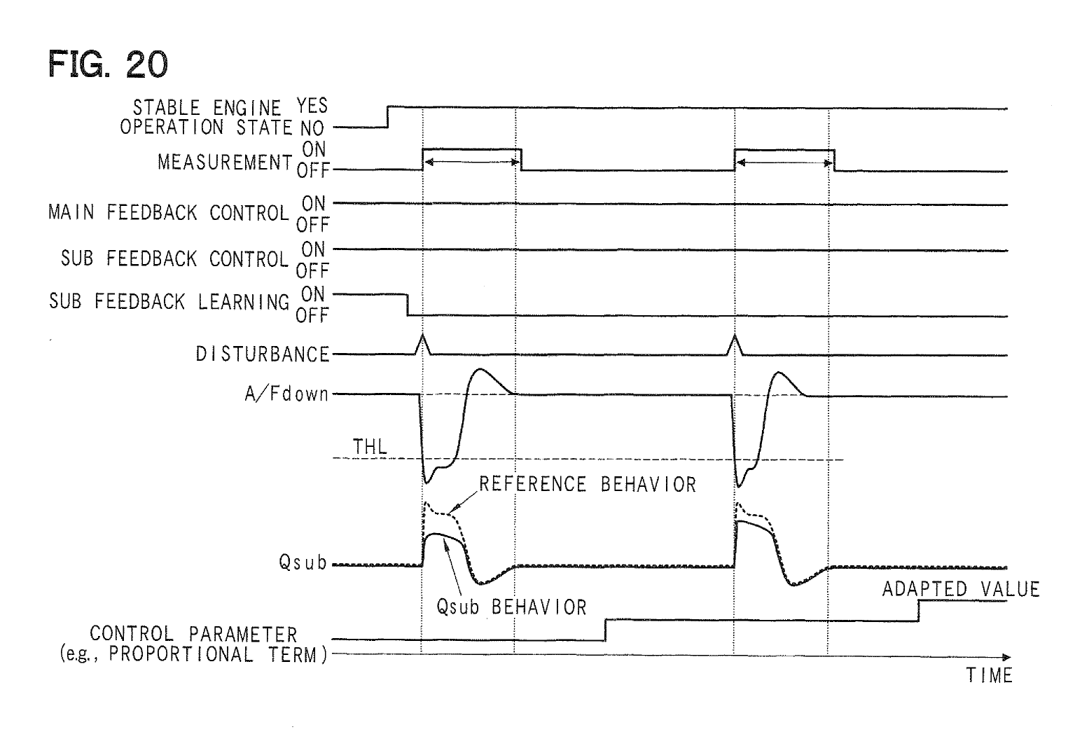

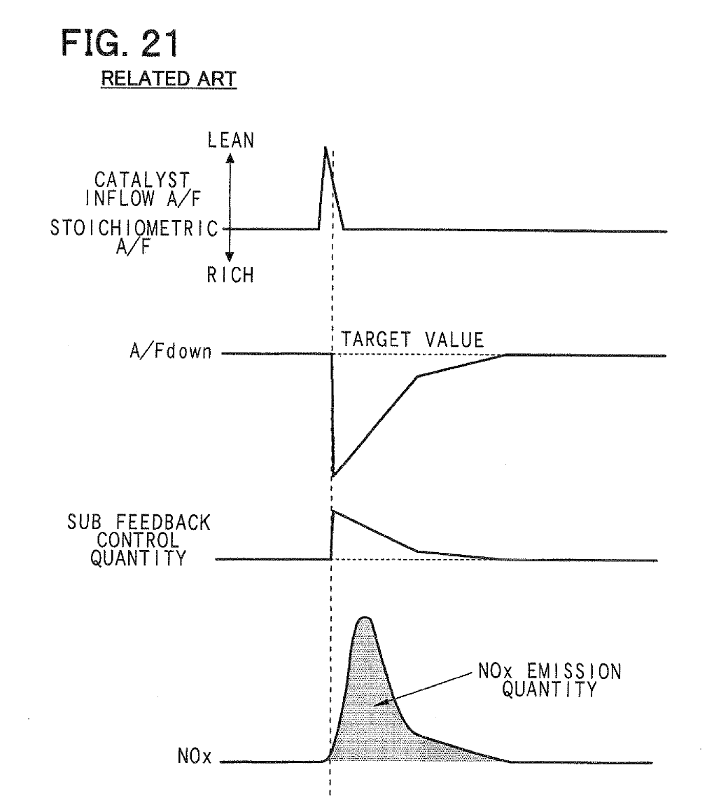

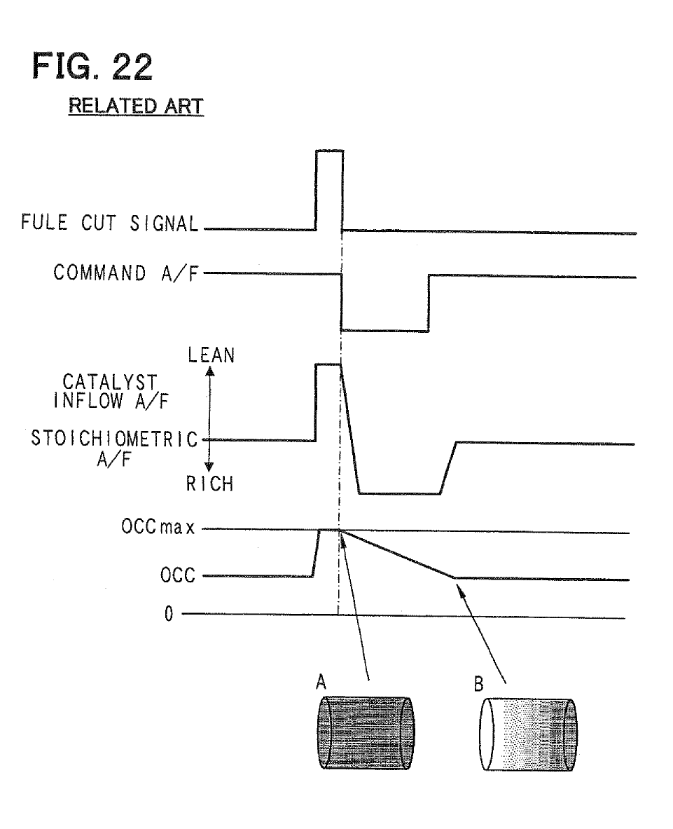

Adapted values of the control parameters of the sub feedback control may be obtained by performing the control parameter changing processing during control system adaptation of the engine 11. In this case, for example as shown in FIG. 20, in the control system adaptation in a development phase or a design phase of the control system of the engine 11, the air-fuel ratio downstream of the catalyst 22 is periodically fluctuated in the lean direction by forcibly causing the lean disturbance, which causes the air-fuel ratio of the exhaust gas flowing into the catalyst 22 to become Jean, while the main feedback control and the sub feedback control are performed in the stable engine operation state. The behavior of the sub correction quantity Qsub is detected every time the output A/Fdown of the downstream sensor 24 becomes a leaner value than the leanness determination value THL. The control parameter changing processing for changing the control parameters of the sub feedback control (such as the differential term, the proportional term and the integral term used for the calculation of the sub correction quantity Qsub) is repeatedly performed multiple times such that the behavior of the sub correction quantity Qsub coincides with the reference behavior based on result of comparison between the behavior of the sub correction quantity and the reference behavior. Thus, the adapted values of the control parameters of the sub feedback control are calculated. In this way, the adapted values of the control parameters of the sub feedback control can be calculated with high precision, and the optimum control parameters can be set.

In the above-described second embodiment, the control parameter changing processing for changing the control parameters of the sub feedback control based on the result of the comparison between the sub correction quantity Qsub (i.e., the correction quantity defined by the sub feedback control) and the reference behavior. The present invention is not limited thereto. Alternatively, control parameter changing processing for changing the control parameters of the sub feedback control based on result of comparison between a behavior of information related to the sub correction quantity Qsub (such as a behavior of the output A/Fdown of the downstream sensor 24) and a reference behavior may be performed.

In the above-described second embodiment, the control parameter changing processing is performed when the output A/Fdown of the downstream sensor 24 becomes a leaner value than the leanness determination value THL. Alternatively, the control parameter changing processing may be performed when the output A/Fdown of the downstream sensor 24 becomes a richer value than a richness determination value.

In the system configuration example of FIG. 1, the air-fuel ratio sensor is used as the upstream sensor 23, and the oxygen sensor is used as the downstream sensor 24. Alternatively, an air-fuel ratio sensor may be used also as the downstream sensor 24. Alternatively, oxygen sensors may be used as both of the upstream sensor 23 and the downstream sensor 24.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. An air-fuel ratio control device of an internal combustion engine having a downstream sensor provided downstream of a catalyst, which purifies exhaust gas of the internal combustion engine, for sensing an air-fuel ratio or a rich/lean state of the exhaust gas, the control device comprising:
an air-fuel ratio controlling means for performing rich/lean input control for supplying a rich component to the catalyst by performing rich input processing, in which increase correction is performed to increase fuel injection quantity stepwise by a certain rich step quantity and then increase correction quantity of the fuel injection quantity is decreased gradually, when an output of the downstream sensor becomes a leaner value than a certain leanness determination value and for supplying a lean component to the catalyst by performing lean input processing, in which decrease correction is performed to decrease the fuel injection quantity stepwise by a certain lean step quantity and then decrease correction quantity of the fuel injection quantity is decreased gradually, when the increase correction quantity of the fuel injection quantity defined by the rich input processing becomes zero or when oxygen occlusion quantity of the catalyst becomes zero; and
a setting means included in the air-fuel ratio controlling means for setting total quantity of the rich component supplied to the catalyst by the rich input processing of the rich/lean input control to a value equal to or larger than an oxygen occlusion capacity of the catalyst.

2. The air-fuel ratio control device as in claim 1, wherein
the internal combustion engine is provided also with an upstream sensor upstream of the catalyst for sensing the air-fuel ratio or the rich/lean state of the exhaust gas, and
the air-fuel ratio controlling means includes:
a feedback control means for performing main feedback control, in which feedback correction of the fuel injection quantity is performed to conform the air-fuel ratio upstream of the catalyst to a target air-fuel ratio based on an output of the upstream sensor, and sub feedback control, in which the main feedback control or the fuel injection quantity is modified based on the output of the downstream sensor; and
an input control means for performing the rich/lean input control by using a control structure of the sub feedback control capable of realizing the rich/lean input control and/or a control parameter of the sub feedback control.

3. The air-fuel ratio control device as in claim 1, wherein
the air-fuel ratio controlling means sets the rich step quantity based on properties of the catalyst when the air-fuel ratio controlling means performs the increase correction for increasing the fuel injection quantity stepwise by the rich step quantity through the rich input processing of the rich/lean input control.

4. The air-fuel ratio control device as in claim 1, wherein
the air-fuel ratio controlling means changes the increase correction quantity in accordance with an index indicating an internal state of the catalyst when the air-fuel ratio controlling means gradually decreases the increase correction quantity of the fuel injection quantity through the rich input processing of the rich/lean input control.

5. The air-fuel ratio control device as in claim 1, wherein
the air-fuel ratio controlling means has another setting means for setting total quantity of the lean component supplied to the catalyst through the lean input processing of the rich/lean input control in accordance with the oxygen occlusion capacity of the catalyst.

6. An air-fuel ratio control device of an internal combustion engine having sensors provided respectively upstream and downstream of a catalyst, which purifies exhaust gas of the internal combustion engine, each for sensing an air-fuel ratio or a rich/lean state of the exhaust gas, the control device comprising:
a main feedback control means for performing main feedback control for performing feedback correction of fuel injection quantity such that the air-fuel ratio upstream of the catalyst conforms to a target air-fuel ratio based on an output of the upstream sensor;
a sub feedback control means for performing sub feedback control for modifying the main feedback control or the fuel injection quantity based on an output of the downstream sensor; and
a control parameter changing means for performing control parameter changing processing for detecting a behavior of sub correction quantity information, which is correction quantity defined by the sub feedback control or information related to the correction quantity, when an output of the downstream sensor crosses a predetermined value during execution of the main feedback control and the sub feedback control and for changing a control parameter of the sub feedback control based on a result of comparison between the behavior of the sub correction quantity information and a predetermined reference behavior.

7. The air-fuel ratio control device as in claim 6, wherein
the control parameter changing means has a modifying means for modifying the behavior of the sub correction quantity information by performing the control parameter changing processing as needed during an operation of the internal combustion engine.

8. The air-fuel ratio control device as in claim 6, wherein
the control parameter changing means has an obtaining means for obtaining an adapted value of a control parameter of the sub feedback control by performing the control parameter changing processing during control system adaptation of the internal combustion engine.

9. The air-fuel ratio control device as in claim 6, wherein
the control parameter changing means has a setting means for setting the reference behavior in accordance with a capacity of the catalyst.

10. The air-fuel ratio control device as in claim 6, wherein
the reference behavior is a behavior of the sub correction quantity information set to perform rich/lean input control for performing rich input processing, in which increase correction is performed to increase fuel injection quantity stepwise by a certain rich step quantity and then increase correction quantity of the fuel injection quantity is decreased gradually, when an output of the downstream sensor becomes a leaner value than a certain leanness determination value and for performing lean input processing, in which decrease correction is performed to decrease the fuel injection quantity stepwise by a certain lean step quantity and then decrease correction quantity of the fuel injection quantity is decreased gradually, when the increase correction quantity of the fuel injection quantity defined by the rich input processing becomes zero or when oxygen occlusion quantity of the catalyst becomes zero.
